(19) United States
(12) Patent Application Publication
(10) Pub. No.: US 2013/0170821 A1
(43) Pub. Date: Jul. 4, 2013

(54) ELECTRONIC DEVICE

(71) Applicants: YONG-JUN YU, Shenzhen City (CN); WEI LIU, Shenzhen City (CN); HE-LI WANG, Shenzhen City (CN); XIAO-HUI ZHOU, Shenzhen City (CN)

(72) Inventors: YONG-JUN YU, Shenzhen City (CN); WEI LIU, Shenzhen City (CN); HE-LI WANG, Shenzhen City (CN); XIAO-HUI ZHOU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/563,840

(22) Filed: Aug. 1, 2012

(30) Foreign Application Priority Data
Dec. 30, 2011 (CN) 201110451946.6

(51) Int. Cl. H04N 5/85

(52) U.S. Cl. 386/361; 386/E05.064

(57) ABSTRACT

An electronic device comprises a main body, a flip cover rotatably connected with the main body, and at least one switching portion. The main body includes at least one through hole. The flip cover includes at least one protrusion corresponding to the at least one through hole. The at least one switching portion comprises an operating portion. The operating portion is slideably received in the at least one through hole and does not protrude from the at least one through hole at any time. When the flip cover covers on the main body, the at least one protrusion is inserted into the at least one through hole to press the at least one switching portion via pressing the operating portion.

### BACKGROUND

1. Technical Field

The present disclosure relates to electronic devices.

2. Description of Related Art

Electronic devices, such as DVD players, include a cover, a main body, and a switching portion. The main body includes a power supply, a spindle motor and a circuit board. The switching portion switches the electrical connection between the spindle motor and the circuit board on or off based on the positional relationship between the cover and the main body. The switching portion includes a pressure head set on the main body and a switch on the circuit board corresponding to the pressure head. The pressure head is partially or wholly exposed from the main body. When the main body is covered by the cover, the pressure head is pressed by the cover and so actuates the switch, and the electrical connection between the power supply and the spindle motor is made to enable the spindle motor. When the cover is pulled up from the main body, the pressure head resumes the original position, and the electrical connection between the power supply and the spindle motor is cut off to disable the spindle motor.

However, because the pressure head protrudes out of the main body, the pressure head may be carelessly pressed to enable the spindle motor.

Therefore, there is room for improvement in the art.

### BRIEF DESCRIPTION OF THE FIGURE

The components of the drawings are not necessarily drawn to scale, the emphasis instead being placed upon clearly illustrating the principles of the embodiment of an electronic device. Moreover, in the drawings, like reference numerals designate corresponding parts throughout several views.

FIG. 1 is a schematic view of an electronic device, according to an embodiment; the electronic device includes two through holes.

FIG. 2 is a partially disassembled view of the electronic device of FIG. 1.

FIG. 3 is a partially enlarged and disassembled view showing the through hole of FIG. 2 from another aspect.

### DETAILED DESCRIPTION

Embodiments of the present disclosure will be described with reference to the drawings.

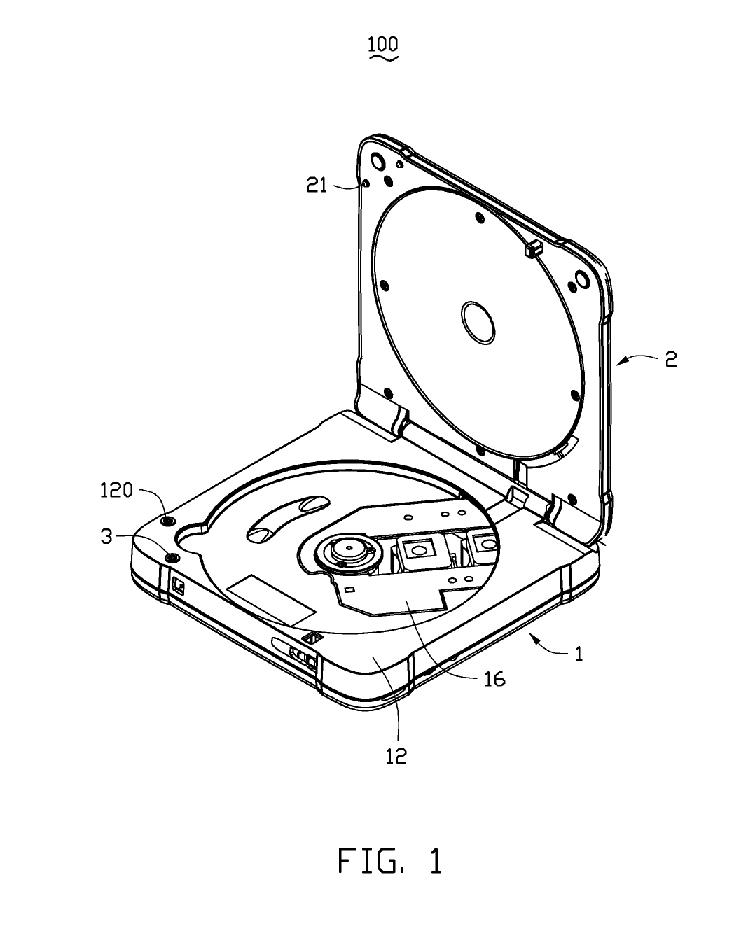

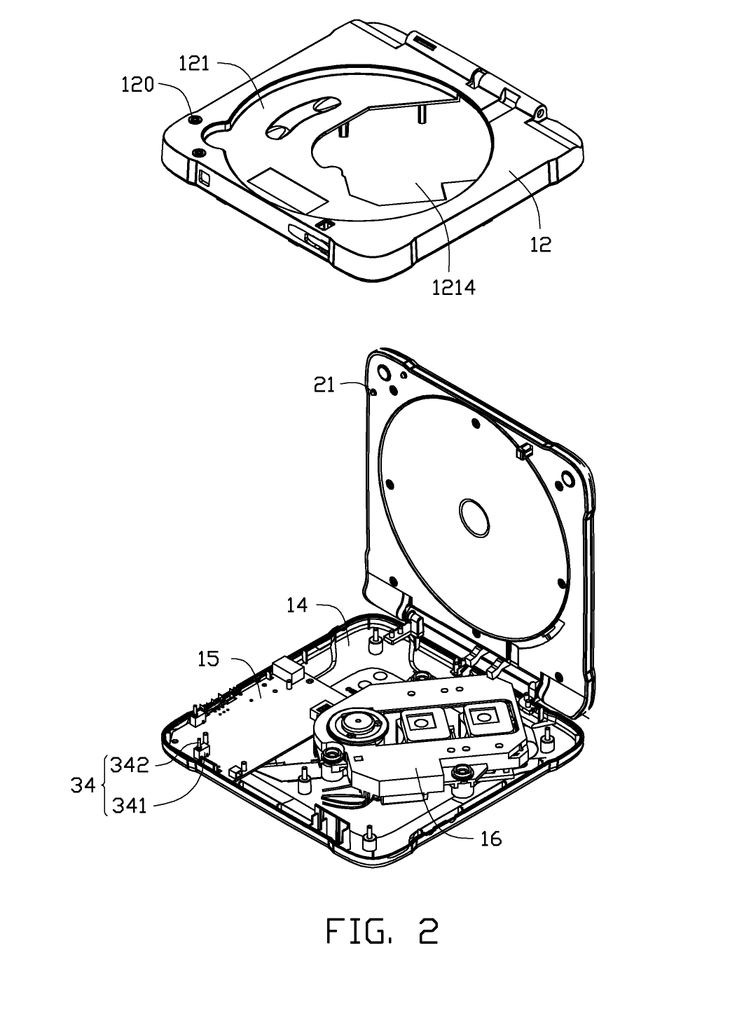

FIGS. 1 and 2 show an electronic device 100. The electronic device 100 includes a main body 1, a flip cover 2 rotatably connected with the main body 1, and two switching portions 3 secured to the main body 1. Each of the switching portions 3 is capable of being activated by the flip cover 2 covering the main body 1, and is inactivated by the flip cover 2 uncovering the main body 1. In the embodiment, the electronic device 100 is a portable DVD player.

The main body 1 includes an upper cover 12, a bottom cover 14, a circuit board 15, and a driving module 16. The upper cover 12 cooperates with the bottom cover 14 to form a cavity (not labeled) for receiving the circuit board 15 and driving module 16.

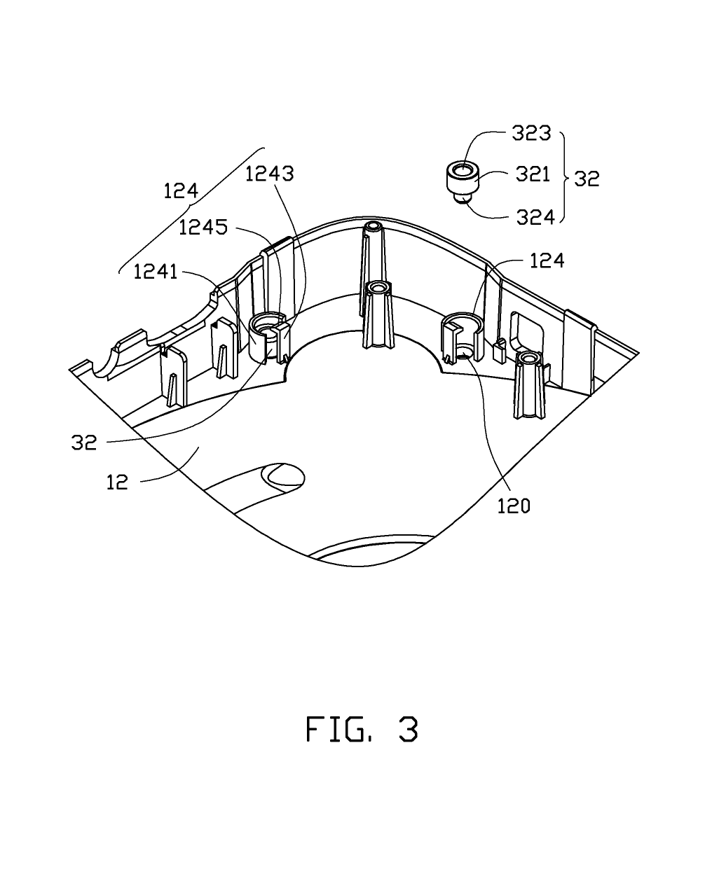

Further referring to FIG. 3, the upper cover 12 is substantially rectangular. The upper cover 12 defines two through holes 120. The through holes 120 are disposed adjacent to an edge of the upper cover 12 opposite to the flip cover 2. In the embodiment, the through holes 120 are symmetrically arranged adjacent to a vertex of the upper cover 12.

The upper cover 12 further includes a recessed portion 121, and two limiting mechanisms 124 corresponding to the through holes 120. The recessed portion 121 is substantially circular. The recessed portion 121 is concaved from an outer the surface of the upper cover 12. The receiving slot 121 is used for receiving a disc. The receiving slot 121 defines an opening 1214.

The limiting mechanisms 124 are perpendicularly arranged at an inner surface of the upper cover 12 and respectively correspond to the through holes 120. The limiting mechanism 124 limits the movement of the switching portion 3 for preventing the switching portion 3 moving in the direction parallel with the upper cover 12. Each limiting mechanism 124 includes a limiting portion 1241 and a blocking plate 1243. The limiting portion 1241 and the blocking plate 1243 are arranged at opposite sides of the through hole 120. The limiting portion 1241 surrounds the through hole 120 and is coaxial with the through hole 120. The horizontal cross-section of the limiting portion 1241 is substantially C-shaped. The blocking plate 1243 is substantially rectangular. The blocking plate 1243 includes a hook 1245. The hook 1245 is bent from an end of the blocking plate 1243 away the upper cover 12 towards the limiting portion 1241. The distance between the hook 1245 and the upper cover 12 is greater than the height of the limiting portion 1241 relative to the upper cover 12. In the embodiment, the distance between the hook 1245 and the upper cover 12 is less than the height of the switching portion 3.

The circuit board 15 (see FIG. 2) is mounted on the bottom cover 14 and is capable of generating a rotating signal.

The driving module 16 mounted on the bottom cover 14 and is electrically connected to the circuit board 15. The diving module 16 is capable of rotating in response to the rotating signal. The driving module 16 is partly exposed from the opening 1214.

Two protrusions 21 protrude from a surface of the flip cover 2 facing the main body 1 and correspond to the through holes 120. The end of the protrusion 21 away from the flip cover 1 is substantially a spherical cap. The protrusion 21 is inserted into a through hole 120 when the flip cover 2 covers the main body 1.

Each switching portion 3 includes a pressing portion 32 corresponding to the limiting mechanism 124 and a switching member 34 engaging with the pressing portion 32 and secured to the circuit board 16. The pressing portion 32 includes a body 321 and an operating portion 324. The body 321 is substantially cylindrical and is used for preventing the pressing portion 32 moving out of the through hole 120. The diameter of the body 321 is larger than the diameter of the through hole 120. An end of the body 321 defines a receiving recess 323. The operating portion 324 is secured to an end of the body 321 opposite to the receiving recess 323 and coaxial with the body 321. The diameter of the operating portion 324 is less than the diameter of the through hole 120, and the height of the operating hole 324 is less than the depth of the through hole 120 in a direction perpendicular to the upper cover 12. The receiving recess 323 makes contact with the switching member 34 when the pressing portion 32 is pressed. In the embodiment, each switching portion 3 has a predetermined distance of travel which is equal to the distance between the hook 1245 and the upper cover 12, and the pressing portion 32 is allowed to move within a range which is less than the predetermined distance of travel to protect the switching member 34 from being damaged.

Referring to FIG. 2 again, the switching member 34 includes a switch 341 and a rod 342 secured to the switch 341. In the embodiment, the switching member 34 is an electronic touch switch. The switch 341 is substantially rectangular and is fixedly mounted on the circuit board 15. An end of the rod 342 is movably received in the switch 341. The rod 342 is made of elastic material.

In assembly, the body 321 is received in the limiting mechanism 124 and is supported by the rod 342 received in the receiving recess 1243 to abut the inner surface of the upper cover 12, and the operating portion 324 is received in the through hole 120. Because the height of the operating hole 324 is less than the depth of the through hole 120 in a direction perpendicular to the upper cover 12, the operating portion 324 does not protrude out of the upper cover 12.

When the flip cover 2 is lowered and covers on the main body 1, the protrusion 21 is inserted into the through hole 120. The pressing portion 32 received in the through hole 120 is pressed by the protrusion 21 to actuate the rod 342 to turn on the switch 341. Thus, an electrical connection between the driving module 16 and the circuit board 15 is established, and the driving module 16 is rotated according to the rotating signal generated by the circuit board 15.

When the flip cover 2 is lifted up from the main body 1, the protrusion 21 moves out of the through hole 120, the rod 342 reverts to the original position via elasticity, and the pressing portion 32 moves towards the upper cover 12 until the body 321 abuts the upper cover 12. Thus, the electrical connection between the driving module 16 and the circuit board 15 is cut off, and the driving module 16 stopped rotating.

While various exemplary and preferred embodiments have been described, the disclosure is not limited thereto. On the contrary, various modifications and similar arrangements (as would be apparent to those skilled in the art) are intended to also be covered. Therefore, the scope of the appended claims should be accorded the broadest interpretation so as to encompass all such modifications and similar arrangements.

What is claimed is:

1. An electronic device, comprising:
a main body defining at least one through hole;
a flip cover rotatably connected with the main body and comprising at least one protrusion corresponding to the at least one through hole; and
at least one switching portion movably secured to the main body;
wherein the at least one switching portion comprises an operating portion; the operating portion is slideably received in the at least one through hole and does not protrudes from the at least one through hole; when the flip cover is covered on the main body, the at least one protrusion is inserted into the at least one through hole to press the at least one switching portion via pressing the operating portion.

2. The electronic device of claim 1, wherein the main body further comprises at least one limiting mechanism perpendicularly arranged surrounding the at least one through hole; the limiting mechanism is used for limiting the at least one switching portion to prevent the switching portion moving in a first direction which is parallel with the main body.

3. The electronic device of claim 2, wherein the at least one limiting mechanism comprises a limiting portion and a blocking plate; the limiting portion and the blocking plate are arranged at opposite sides of the through hole.

4. The electronic device of claim 3, wherein the horizontal cross-section of the limiting portion is substantially C-shaped.

5. The electronic device of claim 3, wherein the blocking plate comprises a hook for limiting the switching portion to move out of the limiting portion in a second direction which is vertical with the main body; the hook is bend from an end of the blocking plate away from the main body towards the limiting portion.

6. The electronic device of claim 5, wherein the distance between the hook and the surface of the main body is larger than the height of the limiting portion relative to the surface of the main body.

7. The electronic device of claim 3, wherein the at least one switching portion further comprises a body received in the limiting portion, and the operating portion is secured to an end of the body; the pressing portion is secured to an end of the body away from the at least through hole; the body is used for preventing the pressing portion moving out of the through hole.

8. The electronic device of claim 7, wherein the diameter of the body is larger than the diameter of the at least one through hole.

9. The electronic device of claim 7, wherein the height of the operating portion is less than the depth of the at least one through hole.

10. The electronic device of claim 7, wherein the at least one switching portion further comprises a switching member; the switching member comprises a switch and a rod movably received in the switch; an end opposite to the switch abuts an end of the body opposite to the operating portion to support the pressing portion away from the hook.
